(19) United States
(12) Patent Application Publication
(10) Pub. No.: US 2023/0195125 A1
(43) Pub. Date: Jun. 22, 2023

(54) METHOD FOR CONTROLLING AN AUTONOMOUS ROBOTIC TOOL

(71) Applicant: HUSQVARNA AB, Huskvarna (SE)

(72) Inventors: Adam Tengblad, Huskvarna (SE); Marcus Homelius, Jönköping (SE); Arvi Jonnarth, Jönköping (SE); Herman Jonsson, Huskvarna (SE); Abdelbaki Bouguerra, Göteborg (SE); Malin Berger, Jönköping (SE); Carmine Celozzi, Jönköping (SE); Adam Ottvar, Göteborg (SE); Georg Hägele, Malmö (SE); Jonas Hejderup, Borås (SE); Åke Wettergren, Mölndal (SE); Stefan Grännö, Jönköping (SE)

(21) Appl. No.: 18/081,989

(22) Filed: Dec. 15, 2022

(30) Foreign Application Priority Data
Dec. 22, 2021 (SE) 2151589-5

(51) Int. Cl. G05D 1/02

(52) U.S. Cl. CPC G05D 1/0214; G05D 1/0234

(57) ABSTRACT

The present disclosure relates to a method for controlling an autonomous robotic tool using a modular autonomy control unit. The control unit includes an interface with the autonomous robotic tool and comprises a processor, configured to control the autonomous robotic tool during operation. The modular autonomy control unit transfers a set of test instructions to the autonomous robotic tool, triggering the latter to carry out a set of test actions in response to the test instructions—The modular autonomy control unit detects sensor input in response to the test actions, and computes a corresponding error vector, based on which calibration data is updated. Then, the modular autonomy control unit controls the robotic tool based on the calibration data. This allows a general control unit to be used in connections with several types of robotic work tools.

### TECHNICAL FIELD

The present disclosure relates to a method for controlling an autonomous robotic tool using a modular autonomy control unit having an interface with the autonomous robotic tool and comprising a processor configured to control the autonomous robotic tool during operation.

### BACKGROUND

Such methods for controlling robotic tools in an autonomous manner may be applied on different types of robotic tools. Using a modular autonomy control unit means that the control unit can be fitted on different types of robotic tools and even be retrofitted on legacy-type tools, initially intended for manual control, which can be given autonomous functionalities. This lowers costs as modular autonomy control units can be produced in larger series without additional development costs.

One problem associated with methods as the one indicated above is how to make the modular autonomy control unit co-operate with a robotic tool in a precise and reliable manner.

### SUMMARY

One object of the present disclosure is therefore to obtain a method for controlling an autonomous robotic tool with improved precision. This object is achieved by means of a method as defined in claim 1. More specifically, in a method of the initially mentioned kind, the following steps are employed. The modular autonomy control unit transfers a set of test instructions to the autonomous robotic tool, and in response to the test instructions, the autonomous robotic tool carries out a set of test actions. The modular autonomy control unit detects sensor input in response to the test actions, computing a corresponding error vector, and updates calibration data based on the error vector. Then, the modular autonomy control unit controls the robotic tool based on the calibration data.

This means that the modular autonomy control unit adapts to properties of the robotic tool to which it is connected in an efficient manner. It may also, depending on the situation, adapt to a new implement connected to a robotic tool with which it is already paired or to properties of the robotic tool changing over time.

The test actions may include a movement of the autonomous robotic tool. During the movement of the autonomous robotic tool, the position of at least one external object may be detected, the position being included in sensor input.

The movement includes a turning of the robotic work tool. One example is a 360 degrees turn of the robotic work tool, and another including driving the robotic work tool along an 8-shaped path.

The at least one external object may be a wall, another option being a pole or beacon which may comprise an identifier, e.g. in the group QRC, bar code, strobe light LED, calibration image.

It is also possible to detect a moving external object, the position thereof being included in sensor input. This may be done while the robotic tool is stationary. The moving external object may be an auxiliary robotic tool.

The modular autonomy control unit may further be adapted to detect an identity of an implement connected to the robotic work tool.

The modular autonomy control unit may receive sensor data from both the robotic work tool and from sensors integrated with the autonomy control unit.

The present disclosure also considers a system for controlling an autonomous robotic tool including a modular autonomy control unit having an interface with the autonomous robotic tool and comprising a processor configured to control the autonomous robotic tool during operation. The modular autonomy control unit is configured to transmit a set of test instructions to the autonomous robotic tool, such that the autonomous robotic tool carries out a set of test actions in response to the test instructions. The modular autonomy control unit is configured to detect sensor input in response to the test actions, to compute a corresponding error vector, and to update calibration data based on the error vector, and wherein the modular autonomy control unit is configured to control the robotic tool based on the calibration data. This system may be varied as outlined in the disclosure of the method above. Then the system is generally configured to carry out the steps defined for the method.

The present disclosure further considers a modular autonomy control unit for controlling an autonomous robotic tool, the modular autonomy control unit comprising an interface for communicating with the autonomous robotic tool and comprising a processor configured to control the autonomous robotic tool during operation. The modular autonomy unit is configured to transmit a set of test instructions to the autonomous robotic tool, such that the autonomous robotic tool carries out a set of test actions in response to the test instructions. The modular autonomy unit is further configured to detect sensor input in response to the test actions, to compute a corresponding error vector, and to update calibration data based on the error vector, wherein the modular autonomy control unit is configured to control the robotic tool based on the calibration data. This control unit may be varied as outlined in the disclosure of the method above. Then the control unit is generally configured to carry out the steps defined for the method.

The modular autonomy control unit may be a separate unit comprising a connector arrangement for connecting to the interface. The modular autonomy control unit may alternatively be integrated with an autonomous robotic tool.

The modular autonomy control unit may be configured to receive sensor data from sensors in the robotic work tool and comprises sensors integrated with the modular autonomy control unit.

The present disclosure also considers a control unit for controlling an autonomous robotic tool, the control unit comprising an interface for communicating with the autonomous robotic tool and comprising a processor configured to control the autonomous robotic tool during operation, the autonomous robotic tool being configured to operate with a plurality of different implements. The control unit is configured to detect the type or identity of a connected implement and update data accordingly. The detecting of the type or identity may be carried out with optical means, such as by reading a barcode or by image detection, or using radio communication, such as reading an RFID tag.

### BRIEF DESCRIPTION OF THE DRAWING

FIG. 1 illustrates a modular autonomy control unit connected to a robotic tool of a first type.

FIG. 2 illustrates a modular autonomy control unit connected to a robotic tool of a second type.

FIG. 3 illustrates the modular autonomy control unit connected to the robotic tool of the first type, but with which is equipped with a different implement.

FIG. 4 illustrates a flow-chart for a basic method according to the present disclosure.

FIG. 5 illustrates a schematic system overview.

FIG. 6 shows a possible test pattern.

FIG. 7 illustrates carrying out a test pattern along a wall.

FIG. 8 illustrates calibrating an autonomy control unit with a stationary robotic tool.

### DETAILED DESCRIPTION

The present disclosure generally relates to autonomous robotic tools, autonomy control units thereof, and methods for controlling autonomous robotic tools. The present disclosure is mainly described in connection with robotic tools intended for gardening, such as lawn mowers, fruit inspection, tending, and picking robots or other multi-purpose garden robots. However the concept to be described is generally applicable to autonomous robotic tools such as concrete grinders, demolition robots, explosives handling robot, only to mention a few examples.

Recent developments in autonomous vehicles such as autonomous cars can often be applied in a similar manner to robotic tools designed for different purposes. However, designing an autonomous robotic tool capable of carrying difficult tasks in a safe and efficient manner is still very complicated and expensive, and often smaller series compared to car production implies that the cost in many cases becomes too high for the consumer market.

The present disclosure seeks to provide autonomous capabilities to various robotic tools in a cost-efficient and reliable manner. The basic idea involves providing a modular autonomy control unit that interfaces with the robotic tools and adapts its processing algorithms thereto. This means that the modular autonomy control unit can be used for several different robotic tools and robotic tools used in different situations as will be described. Thanks to this feature autonomy can be provided a much more cost-efficient manner.

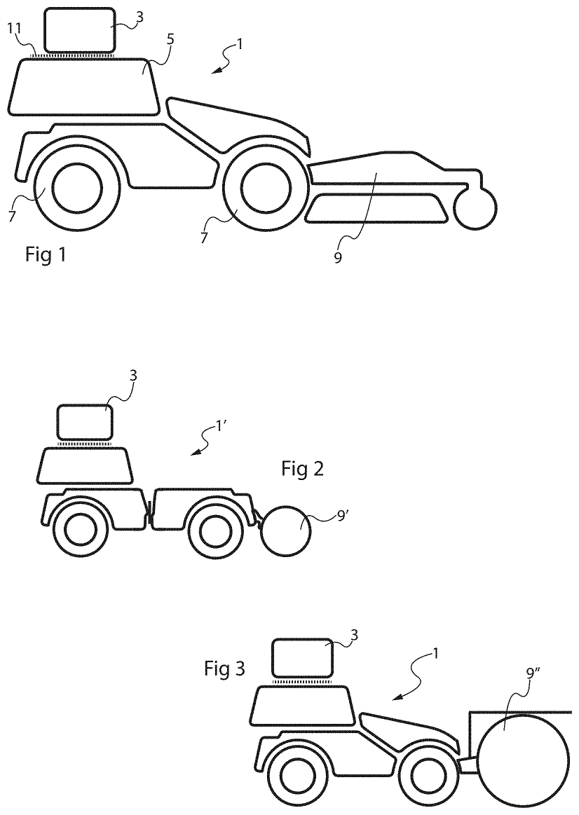

FIG. 1 illustrates a robotic tool 1 of a first type which is provided with a modular autonomy control unit 3. In the illustrated case, the robotic tool is a robotic garden tool 1 comprising control means 5 for driving and/or steering wheels 7 of the robotic garden tool 1 as well as controlling an implement 9 connected to the robotic garden tool 1, in the illustrated case a lawn mowing implement 9. The autonomy control unit 3 is connected to the robot control means 5 via an interface 11, through which control information and sensor data is communicated as will be shown.

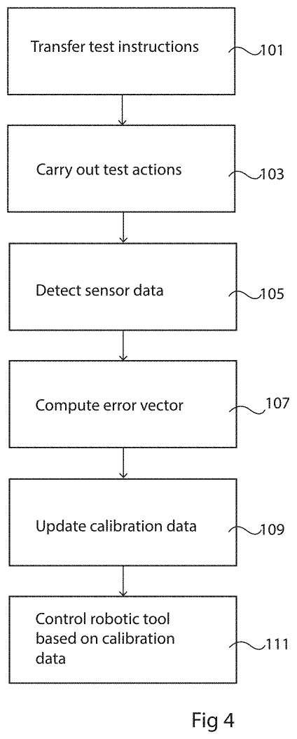

A basic method for operating the robotic tool with the modular autonomy control unit is illustrated in FIG. 4.

In a first step, the modular autonomy control unit 3 transfers 101 a set of test instructions to the control means 5 of the autonomous robotic tool. Typical such test instructions will be described in greater detail, but generally they are designed to make the robotic tool carry out actions that result in sensor data that allows the modular autonomy control 3 unit to establish how the robotic tool moves around and records sensor data correspondingly. Such test instructions may be given on different levels depending on the capability and sophistication of the control means 5 of the robotic tool 1.

In a second step, the autonomous robotic tool carries out 103 a set of test actions in response to the received test instructions. As mentioned, examples of those actions will be described, but typically they include moving the robotic tool and activating different functions. It should be noted that the first and second step to a great extent may take place simultaneously, the robotic tool carrying out actions based on a first set of instructions while receiving a second set of instructions.

Then, the modular autonomy control unit detects 105 sensor input in response to the test actions. This may be based on sensor data received from the robotic tool 1 as well as sensor data generated in the modular autonomy control 3 unit itself.

A corresponding error vector is computed 107 based on the detected sensor data. This error vector is based on predicted sensor data and actual received sensor data. Again this step need not necessarily await the completion of the previous steps, but can be carried out simultaneously therewith.

Finally, calibration data in the modular autonomy control 3 unit is updated 109 based on the established error vector, and the modular autonomy control unit controls 111 the robotic tool based on the calibration data.

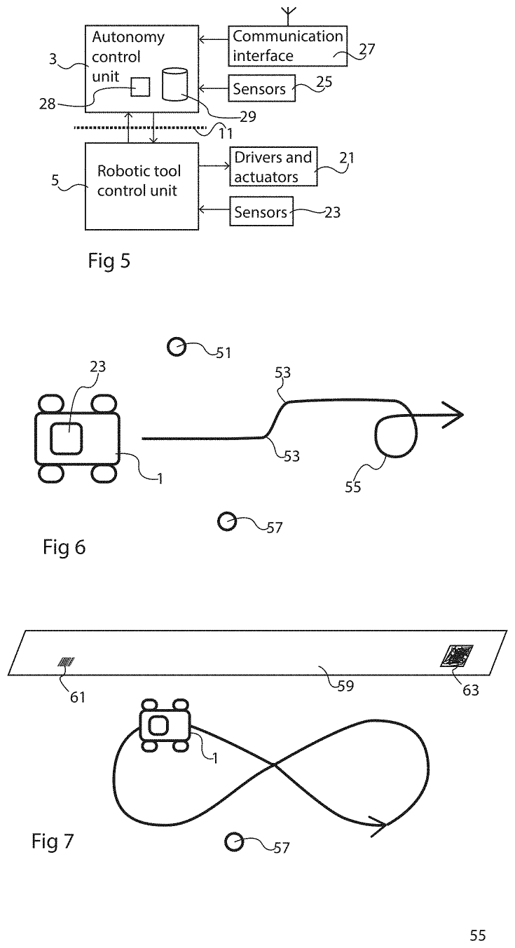

FIG. 5 schematically illustrates the components involved in the process outlined above. As already mentioned, the modular autonomy control 3 communicates with control means 5 of the robotic tool via an interface 11, typically sending instructions and receiving sensor and/ or operational data. The control means 5 of the robotic tool carries out the low-level steering of the robotic tool, by controlling power supplied to electric motors driving the robot wheels 7, steering angles thereof such as wheels steering and articulated angles, as well as controlling implement functions carried out, for instance cutting disc speed and height on a lawn mowing implement. The control means 5 of the robotic tool thus controls drivers and actuators 21 of the robotic tool, optionally both based on its own algorithms and on instructions received form the modular autonomy control 3.

It should be noted that instructions sent from the modular autonomy control unit 3 to the control means 5 of the robotic tool can relate to different levels of control, while it would in principle be possible for the modular autonomy control unit 3 to control individual motor currents, for instance, in the robotic tool, it is usually more appropriate to provide higher level commands or instructions, such as ‘drive forward 70% speed’ or ‘maintain speed and turn left 20 degrees’, for example. In general, the modular autonomy control unit 3 in this sense functions in much the same way as a human driver, and as will be discussed the modular autonomy control unit 3 may in some cases actually replace such human drivers.

While sending instructions, the modular autonomy control unit 3 may also receive sensor data from different sensors 23 connected to or integrated with the control means 5 of the robotic tool. Sensors 23 in this sense is a broad term. I addition to data from dedicated sensors such as cameras, temperature sensors, etc. steering data otherwise unknown to the modular autonomy control unit can be included such as driving parameters provided by the robotic control means 5 itself.

The modular autonomy control unit 3 itself may comprise sensors 25 that provide data in addition to the data received from the robotic tool control means 5. Typically, this may include sensors related to autonomous driving such as LIDARs, cameras, Real-time kinematics (RTK) positioning devices, etc.

The modular autonomy control unit 3 may also comprise a communications interface 27 which allows it to react on remote information and/or instructions, for instance weather forecasts.

Based on the test instruction sent and the sensor data recorded in response thereto, the modular autonomy control unit 3 processes, using a processor 28, an error vector that is used to update calibration data in a memory 29 accessible to the control unit.

FIG. 2 illustrates a modular autonomy control unit connected to a robotic tool 1′ of a type different from the first type of FIG. 1. This robotic tool is articulated and thus has steering and driving properties that differ from the first type. Further, another type of implement 9′ is used. By carrying out the calibration sequence indicated above in connection with FIG. 4, the modular autonomy unit 3 can adapt to this robotic tool 1′. Therefore a common modular autonomy unit 3 can be produced for both robotic tools.

FIG. 3 illustrates the modular autonomy control unit connected to the robotic tool 1 of FIG. 1, but with which is equipped with a different implement 9″. The change of implement, e.g. as illustrated from a lawn mowing device to a brush for paved surfaces, changes the driving properties as well. The same applies for other implements such a snowplough, for instance. However, the disclosed calibration sequence allows the modular autonomy unit 3 to adapt also to this situation.

When changing from one implement to another, the modular autonomy unit 3 may detect the identity of the connected implement. This may be accomplished in different ways. To start with a specific identity can be read, e.g. the modular autonomy unit 3 can detect and RFID tag on the implement or read a QR code or other visual identity mark on the implement. It is however also possible to detect the identity or type of the implement in more indirect ways for instance by detecting characteristic signals output by the implement if being controlled by electronics. Also, the weight of the implement can be used for detection as well as image detection if the modular autonomy unit 3 has access to a camera viewing the implement.

The modular autonomy unit 3 may update driving and inertia properties based on the detected implement identity or type. This may therefore simplify the updating of calibration parameters. However, is also possible to use this information for route planning etc. for instance communicating the detected type or identity to a remote service planning the work of the robotic tool. The identification of the implement therefore goes beyond mere autonomy controlling and may be carried out by a general control device in the robotic tool.

The present disclosure therefore considers a control unit for controlling an autonomous robotic tool, the control unit comprising an interface for communicating with the autonomous robotic tool. The autonomous robotic tool is configured to operate with a plurality of different implements. The control unit is configured to detect the type or identity of a connected implement.

It is also possible to update the calibration data regularly without change of implement, to compensate for changes in the properties of the robotic tool 1 during use. For instance, cut grass may become stuck under the robotic tool making it heavier, and the modular autonomy unit 3 may be updated to compensate for this.

With reference again to FIG. 4, the test actions carried out 103 are designed to produce sensor data to be detected 105 characterizing the robotic tool's properties. Those test actions can be carried out in different ways as will now be discussed.

In a first example illustrated in FIG. 6, the autonomous robotic tool 1 moves along a path, allowing sensors 23 to detect an external object 51. The external object 51 may be any object in the vicinity of the robot 1 that is detectable to the sensors 23, although some specific objects may involve advantages as will be described.

Although already a straight movement path allows the autonomy control unit to detect properties of the autonomous robotic tool, typically the movement thereof based on an input driving signal making the detected position of the external object 51 to move in relation to the autonomous robotic tool 1. However adding one or more turns 53 to the path adds steering information thereto, further allowing the modular autonomy control unit to detect steering properties

The turning may include a 360-degree turn 55 of the robotic work tool 1 or even better an 8-shaped turning, which involves turning both left and right.

Although as mentioned any external object 51 can be used for detection it may be preferred to use dedicated external objects such as for instance a pole or beacon 57 having means facilitating detection of the beacon as such, for instance a bar code or an RFID tag. A QRC, a strobe light LED, or a calibration image would be another option. It is also possible to provide two or more such beacons at a known mutual distance. This allows the measuring of the distance the robotic tool travels by means of a camera for instance, and that distance can be compared with a corresponding distance measured by an inertial measurement unit such as including accelerometers, for instance.

FIG. 7 illustrates a version where external object is a wall 59. Driving along the wall 59 and varying the distance thereto, for instance as illustrated by driving as an ‘8’, provides a wide variety of sensor signals that may improve calibration. Providing identifiers such as a bar code 61 or another identifiable image 63 at a location on the wall 59 may provide enhanced sensor data. Also in this case a beacon 57 or another object may be provided, separate from the wall 59.

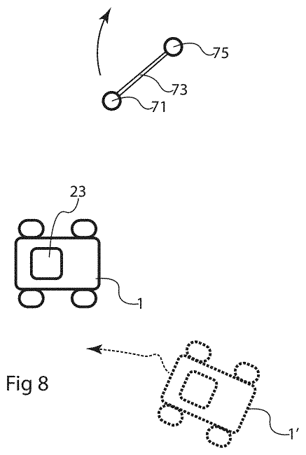

FIG. 8 illustrates yet another example. In this case the robotic tool is stationary, i.e. the test actions include only sensing of the environment. This is done in connection with a moving object 71, which may for instance be mounted on a rotating beam 73 driven by a motor 75. This allows the testing of the sensors available to the autonomy control unit 23 in isolation from the driving of the robotic tool 1 and may typically be included as one part of a sequence also involving a moving robotic tool 1.

As yet another alternative, an auxiliary robotic tool 1′ which moves provides a sensor input to the autonomy control unit 23. It is even possible to let the autonomy control unit 23 control that auxiliary robotic tool 1′ in order to induce sensor data from the robotic tool with which it is connected.

The present invention is not limited to the above described examples and can be altered and varied in different ways within the scope of the appended claims.

1. A method for controlling an autonomous robotic tool using a modular autonomy control unit having an interface with the autonomous robotic tool and comprising a processor configured to control the autonomous robotic tool during operation, the method comprising:
the modular autonomy control unit transferring a set of test instructions to the autonomous robotic tool,
the autonomous robotic tool carrying out a set of test actions in response to the test instructions,
the modular autonomy control unit detecting sensor input in response to the test actions, computing a corresponding error vector, and updating calibration data based on the error vector, and
the modular autonomy control unit controlling the robotic tool based on the calibration data.

2. The method according to claim 1, wherein said test actions includes a movement of the autonomous robotic tool.

3. The method according to claim 2, wherein, during the movement of the autonomous robotic tool, a position of at least one external object is detected, a position being included in sensor input.

4. The method according to claim 2, wherein the movement includes a turning of the autonomous robotic tool.

5. The method according to claim 4, wherein the turning includes a 360 degrees turn of the autonomous robotic tool.

6. The method according to claim 4, wherein the turning includes driving the autonomous robotic tool along an 8-shaped path.

7. The method according to claim 3, wherein said at least one external object is a wall.

8. The method according to claim 3, wherein said at least one external object is at least one pole or beacon.

9. The method according to claim 8, wherein said at least one pole or beacon comprises an identifier in the group QRC, bar code, strobe light LED, and calibration image.

10. The method according to claim 1, wherein a moving external object is detected, a position of the moving external object being included in sensor input.

11. The method according to claim 10, wherein the robotic tool is stationary while detecting the moving external object.

12. The method according to claim 10, wherein the moving external object is an auxiliary robotic tool.

13. The method according to claim 1, wherein the modular autonomy control unit is further adapted to detect an identity of an implement connected to the autonomous robotic tool.

14. The method according to claim 1, wherein the modular autonomy control unit receives sensor data from both the robotic work tool and sensors integrated with the autonomous robotic tool.

15. A system for controlling an autonomous robotic tool including a modular autonomy control unit having an interface with the autonomous robotic tool and comprising a processor configured to control the autonomous robotic tool during operation, wherein the modular autonomy control unit is configured to transmit a set of test instructions to the autonomous robotic tool, such that the autonomous robotic tool carries out a set of test actions in response to the test instructions, wherein the modular autonomy control unit is configured to detect sensor input in response to the test actions, to compute a corresponding error vector, and to update calibration data based on the error vector, and wherein the modular autonomy control unit is configured to control the robotic tool based on the calibration data.

16. A modular autonomy control unit for controlling an autonomous robotic tool, the modular autonomy control unit comprising an interface for communicating with the autonomous robotic tool and comprising a processor configured to control the autonomous robotic tool during operation, the modular autonomy control unit being configured to
transmit a set of test instructions to the autonomous robotic tool, such that the autonomous robotic tool carries out a set of test actions in response to the test instructions, and
detect sensor input in response to the test actions, to compute a corresponding error vector, and to update calibration data based on the error vector, wherein the modular autonomy control unit is configured to control the autonomous robotic tool based on the calibration data.

17. The modular autonomy control unit according to claim 16, wherein the modular autonomy control unit is configured to receive sensor data from sensors in the robotic work tool and comprises sensors integrated with the modular autonomy control unit.

18. The modular autonomy control unit according to claim 16, wherein the modular autonomy control unit is a separate unit comprising a connector arrangement for connecting to the interface.

19. The modular autonomy control unit according to claim 16, wherein the modular autonomy control unit is integrated with the autonomous robotic tool.

20. A control unit for controlling an autonomous robotic tool the control unit comprising an interface for communicating with the autonomous robotic tool and comprising a processor configured to control the autonomous robotic tool during operation, the autonomous robotic tool being configured to operate with a plurality of different implements characterized by the control unit being configured to detect the type or identity of a connected implement and update data accordingly.

21. The control unit according to claim 20, wherein the control unit detects the type or identity with optical means by reading a barcode or by image detection, or using radio communication.
